(19) United States
(12) Patent Application Publication
(10) Pub. No.: US 2019/0141310 A1
(43) Pub. Date: May 9, 2019

(54) REAL-TIME, THREE-DIMENSIONAL VEHICLE DISPLAY

(71) Applicant: Intel Corporation, Santa Clara, CA (US)

(72) Inventors: Daniel POHL, Puchheim (DE); Oliver Grau, Voelklingen (DE)

(21) Appl. No.: 16/234,619

(22) Filed: Dec. 28, 2018

(51) Int. Cl. H04N 13/122; H04N 13/282; B60R 1/00

(52) U.S. Cl. CPC H04N 13/122; H04N 13/282; B60R 2300/20; B60R 2300/105; B60R 2300/30; B60R 1/00

(57) ABSTRACT

Herein is disclosed a vehicle comprising a plurality of image sensors, configured to detect image data of a vicinity of the vehicle from a plurality of views; a receiver, configured to receive the detected image data and deliver the detected image data to one or more processors, and the one or more processors, configured to generate from the detected image data a virtual three-dimensional reconstruction of the vicinity of the vehicle; and output the three-dimensional image in real-time.

### TECHNICAL FIELD

Various aspects relate generally to comparison of images to generate real-time, three-dimensional images of a vicinity of a vehicle.

### BACKGROUND

In driver-operated vehicles, windows are traditionally the primary means for drivers to obtain visual data of areas outside of the vehicle. Some modern vehicles include displays, which may depict two-dimensional representations of an area outside the vehicle, such as for assisting in parking or driving in reverse. In this manner, one or more 2D camera feeds may be displayed to provide information about a region in a vicinity of the vehicle which the driver may not be able to otherwise directly visualize. It may be known to provide one or more overlays on the video feed, such as an estimated path of the vehicle based on the surroundings and current steering wheel position.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 shows a conventional vehicle configuration of windows and supports;

FIG. 2 shows a 3D recreation based on comparison of image data offset along a y-axis;

FIG. 3 shows a 3D recreation based on comparison of image data offset along an x-axis;

FIG. 4 shows an image modification to highlight some elements by reducing an opacity of other elements;

FIG. 5 shows an analysis of visibility degradation in fog;

FIG. 6 shows identification and reduction of distracting material, according to an aspect of the disclosure;

FIG. 7 shows use of image data to increase visibility across obstacles;

FIG. 8 shows a flowchart for rendering a modified reality image;

FIG. 9 shows artificial intelligence for semantic labeling and cognitive augmentation;

FIG. 10 shows a model for 3D data analysis;

FIG. 11 shows a model for semantic labelling; and

FIG. 12 shows a method of real-time three-dimensional image reconstruction.

### DESCRIPTION

According to various aspects, information (e.g., obstacle identification information, obstacle condition information, etc.) may be handled (e.g., processed, analyzed, stored, etc.) in any suitable form, e.g., data may represent the information and may be handled via a computing system. The obstacle condition may be used herein with the meaning of any detectable characteristic of the obstacle itself and/or associated with the obstacle. As an example, in the case that the obstacle is a vehicle, a driver, a passenger, a load, etc., may be associated with the vehicle. A risk that originates from a person or object that is associated with the obstacle, may be treated in the analysis (as described herein) as a risk potential assigned to the obstacle.

In some aspects, one or more range imaging sensors may be used for sensing obstacles and/or persons and/or objects that are associated with an obstacle in the vicinity of the one or more imaging sensors. A range imaging sensor may allow associating range information (or in other words distance information or depth information) with an image, e.g., to provide a range image having range data associated with pixel data of the image. This allows, for example, providing a range image of the vicinity of a vehicle including range information about one or more objects depicted in the image. The range information may include, for example, one or more colors, one or more shadings associated with a relative distance from the range image sensor, etc. According to various aspects, position data associated with positions of objects relative to the vehicle and/or relative to an assembly of the vehicle may be determined from the range information. According to various aspects, a range image may be obtained, for example, by a stereo camera, e.g., calculated from two or more images having a different perspective. Three-dimensional coordinates of points on an object may be obtained, for example, by stereophotogrammetry, based on two or more photographic images taken from different positions. However, a range image may be generated based on images obtained via other types of cameras, e.g., based on time-of-flight (ToF) measurements, etc. Further, in some aspects, a range image may be merged with additional sensor data, e.g., with sensor data of one or more radar sensors, etc.

In one or more aspects, a driving operation (such as, for example, any type of safety operation, e.g., a collision avoidance function, a safety distance keeping function, etc.) may be implemented via one or more on-board components of a vehicle. The one or more on-board components of the vehicle may include, for example, one or more cameras (e.g., at least a front camera), a computer system, etc., in order to detect obstacles (e.g., at least in front of the vehicle) and to trigger an obstacle avoidance function (e.g., braking, etc.) to avoid a collision with the detected obstacles. The one or more on-board components of the vehicle may include, for example, a one or more cameras (e.g., at least a front camera), a computer system, etc., in order to detect another vehicle (e.g., at least in front of the vehicle) and to follow the other vehicle (e.g., autonomously) or at least to keep a predefined safety distance with respect to the other vehicle.

In various aspects, a depth camera (or any other range image device) may be used, for example, aligned at least in the forward driving direction to detect during driving when an obstacle may come too close and would cause a collision with the vehicle. In a similar way, at least one depth camera (or any other range image device) may be used, for example, that is aligned in the rear driving direction to avoid a collision in the case that an obstacle approaches from this direction.

According to various aspects, one or more sensors and a computing system are used to implement the functions described herein. The computing system may include, for example, one or more processors, one or more memories, etc. The computing system is communicatively coupled to the one or more sensors (e.g., of a vehicle) to obtain and analyze sensor data generated by the one or more sensors. According to some aspects, the one or more processors are configured to generate depth images in real-time from the data received from one or more range imaging sensors and analyze the depth image to find one or more features associated with conditions that represent a risk potential.

Real-time is used herein to describe the rapid rendering of three-dimensional (3D) graphic information from a plurality of two-dimensional (2D) images. A person skilled in the art may distinguish real-time rendering from non-real-time rendering. According to one aspect of the disclosure, real-time may require that a duration between receipt of 2D image data and output of a 3D image does not exceed 1/30^{th} of a second. Real-time need not be instantaneous or simultaneous, as some degree of latency may still be acceptable in a real-time system. According to one aspect of the disclosure, less than 200 milliseconds is an acceptable degree of latency for a real-time system. According to another aspect of the disclosure, less than 100 milliseconds is an acceptable degree of latency for a real-time system. According to another aspect of the disclosure, less than 20 milliseconds is an acceptable degree of latency for a real-time system. According to another aspect of the disclosure, less than 10 milliseconds is an acceptable degree of latency for a real-time system.

Several aspects are described herein exemplarily with reference to a motor vehicle, wherein one more other vehicles represent obstacles in a vicinity of the motor vehicle. However, other types of vehicles may be provided including the same or similar structures and functions as described exemplarily for the motor vehicle. Further, other obstacles may be considered in a similar way as described herein with reference to the other vehicles.

Since the development of the motor vehicle in the early twentieth century, it may be argued that the fundamental design of vehicles has changed relatively little. Most vehicles include a chassis with at least four wheels, on which a carriage for a driver is mounted. The carriage is generally surrounded by front, rear, and side windows to permit the driver to directly visualize the vicinity of the vehicle. These windows also traditionally serve the purpose of protecting the driver from environmental hazards, such as changing temperatures and precipitation. In almost all cases, vehicle windows are supported by opaque frames or structural supports, which can result in blind spots.

By comparison to the field of aviation, it may be known to replace the windows of an airplane with screens, which may be used to project images. In some installations, the screens may be lighter than glass or plastic windows, thereby reducing the overall weight of the aircraft, which corresponds to a resultant fuel savings. Similarly, and according to one aspect of the disclosure, one or more windows of a vehicle may be replaced by one or more screens. By reducing or eliminating the need for a vehicle's windows, the resulting vehicle may be lighter and similarly correspond to a resulting reduction in fuel requirements.

Instead of relying on a vehicle's windows to permit a visual connection between a driver and a vicinity on the outside of the vehicle, one or more screens may be used for this purpose. Such screens may be installed anywhere within the vehicle. According to one aspect of the disclosure, one or more screens are installed on an interior panel or region of the vehicle. According to another aspect of the disclosure, one or more screens are installed in an area traditionally associated with a window. In this way, screens replace one or more vehicle windows, such that the resulting vehicle has fewer windows than a conventional vehicle or no windows at all. According to one aspect of the disclosure, the resulting vehicle is made entirely without windows, and screens provide the only visual connection between the driver and an outside vicinity of the vehicle.

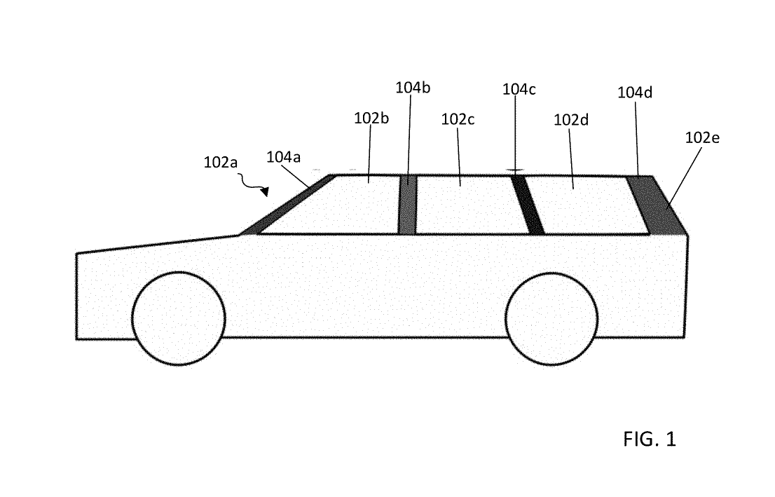

FIG. 1 depicts a conventional vehicle configuration, wherein visual information of an extra-vehicular vicinity is provided to the driver through one or more windows. In this case, the vehicle is designed with eight large window surfaces, which permit the driver to directly visualize a vicinity of the vehicle. These include the front windshield 102a, two front side windows 102b, two middle side windows 102c, two rear side windows 102d, and a rear window 102e. The windows are reinforced and supported by a number of support structures. For example, the front windshield 102a is supported by a generally rectangular frame of structures as indicated by 104a, part of which also support the front side windows 102b. The front side windows 102b are further supported by a second set of window supports 104b, which also partially support the middle side windows 102c. The middle side windows 102c are further supported by additional structural supports 104c, which also support the reader side windows 102d. The rear side windows 102d are also supported by rear supports 104d, which also serve to support the rear window 102e. Although the supports provide structural reinforcement, they also inhibit direct visualization, That is, vehicles with windows are associated with blind spots, due to their structural supports, which prevent the driver from directly visualizing areas exterior to the vehicle. Although some impaired visualization associated with blind spots may be at least partially overcome through installation of mirrors or other sight devices, some level of impaired visualization is likely to remain.

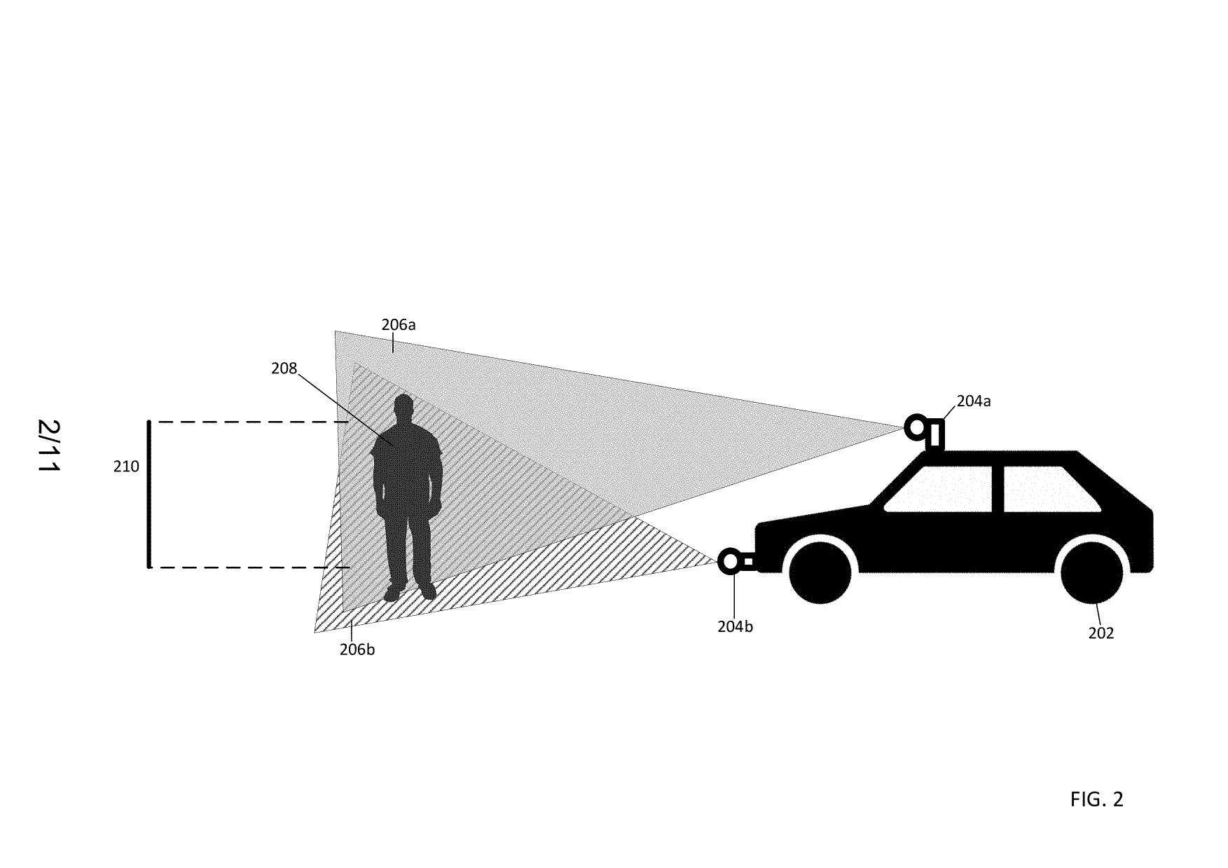

FIG. 2 depicts a comparison of image data from image sensors placed with a differential along a y-axis. In this figure, a vehicle 202 is depicted with at least two image sensors 204a and 204b, each mounted to the vehicle and placed with a differential along a y-axis. That is, the sensor 204a is placed higher than the sensor 204b. The image sensors are directed to detect image data corresponding to at least a common vicinity. As depicted, detection region 206a corresponds to image sensor 204a, and detection region 206b corresponds to image sensor 204b. Detection regions 206a and 206b overlap. An obstacle is depicted as 208. Although either image sensor may be capable of detecting the obstacle 208 and rendering a 2D image of the obstacle, the two image sensors will receive image data of the obstacle, as taken from different vantages. The image data will be processed by one or more processors, which are configured to implement at least one photogrammetry procedure to determine depth information associated with the obstacle 208 through a comparison of the images from different vantages. In so doing, the one or more processors are configured to generate a 3D recreation of the obstacle. This procedure is not be limited to a specific obstacle, but is implemented for a vicinity of the vehicle of any size or distance, depending on the configuration of the two or more image sensors. In this particular example, the photogrammetry depth detection and subsequent 3D generation is dependent on the difference in vantages, which are indicated herein by a difference in position along a y-axis, as indicated by 210.

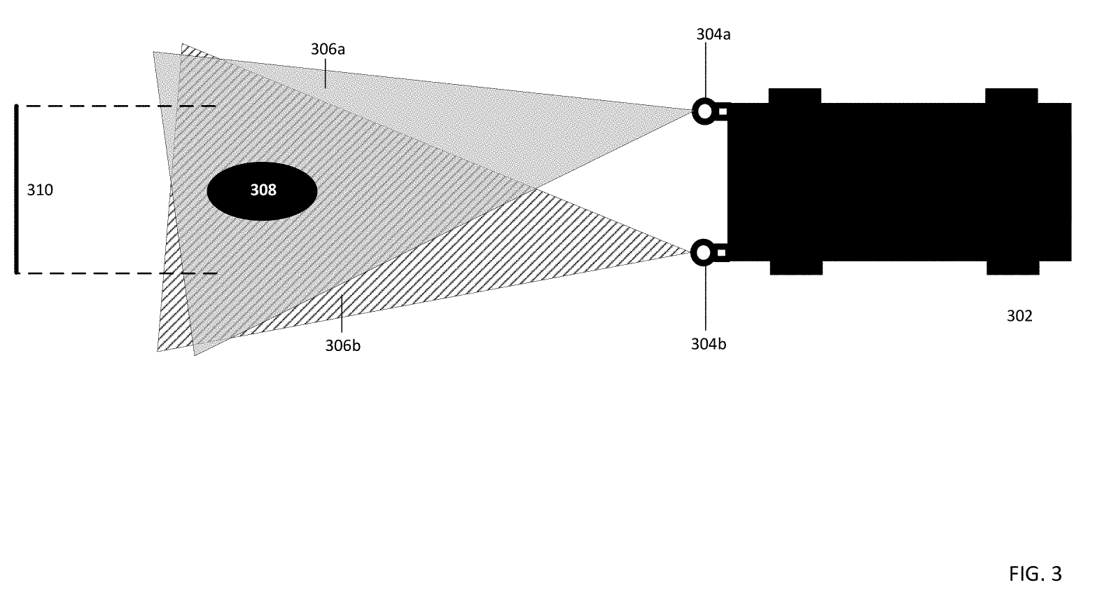

FIG. 3 shows an aerial view of the vehicle 302 with image sensors depicted with a difference in placement along an x-axis. In this manner, the vehicle 302 is equipped with a first image sensor 304a and a second image sensor 304b, which are placed with a differential along an x-axis. Image sensor 304a corresponds to a detection region 306a, and image sensor 304b corresponds to a detection region 306b, with the two detection regions at least partially overlapping. Within the two detection regions is an obstacle 308. Each image sensor transmits its detected image data to one or more processors, which perform at least one photogrammetry procedure by comparing the image data. In so doing, the one or more processors detect depth information associated with the obstacle 308 and generate a 3D recreation of the vicinity of the vehicle. In this example, this is made possible at least because of the difference in placement along the x-axis. Although all of the examples in FIG. 2 and FIG. 3 are depicted with differences along the y-axis or x-axis in isolation, the differences in placement may be combined along any combination of x-axis, y-axis or z-axis.

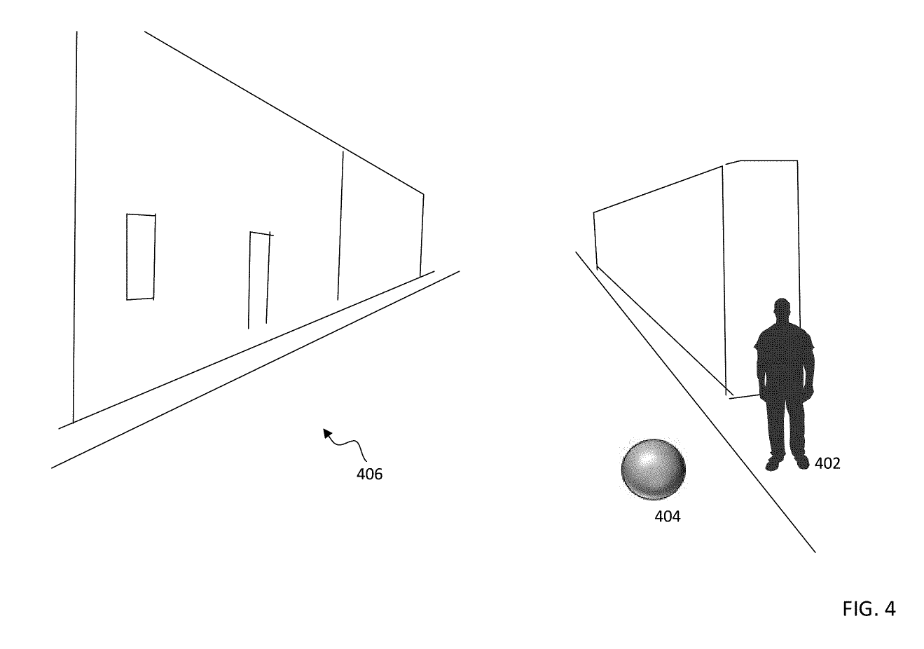

FIG. 4 depicts an image modification according to an aspect of the disclosure. The one or more processors may be further configured to analyze the image data or 3D recreation to detect a danger or hazard. The criteria for detecting dangers or hazards may be any criteria whatsoever, as desired for the given implementation. Examples of such criteria may include, but are not limited to, obstacles in the roadway, obstacles near the roadway, persons in the roadway, persons near the roadway, the presence of children, decelerating vehicles, stopped vehicles, vehicles within a predefined distance from the driver's vehicle, etc. In this case, two potential hazards are depicted. The first hazard is a person within close proximity of the roadway 402. The second hazard is an obstacle 404 within the roadway 406. In this manner, the one or more processors may be configured to distinguish between a first category of hazards and a second category of non-hazards, and to modify the resulting image accordingly. As such, the first category of hazards, including elements 402 and 404 may be displayed in color (as represented herein by depicting shaded objects), whereas the non-hazards may be altered in appearance, such as by being made transparent, nearly transparent, black-and-white, grayscale, or otherwise. Distinctions between the first category and the second category may be made by any means to draw attention to the hazard. Such distinctions may include, but are not limited to, changes in brightness, changes in color saturation, changes in transparency, changes in opacity, or otherwise.

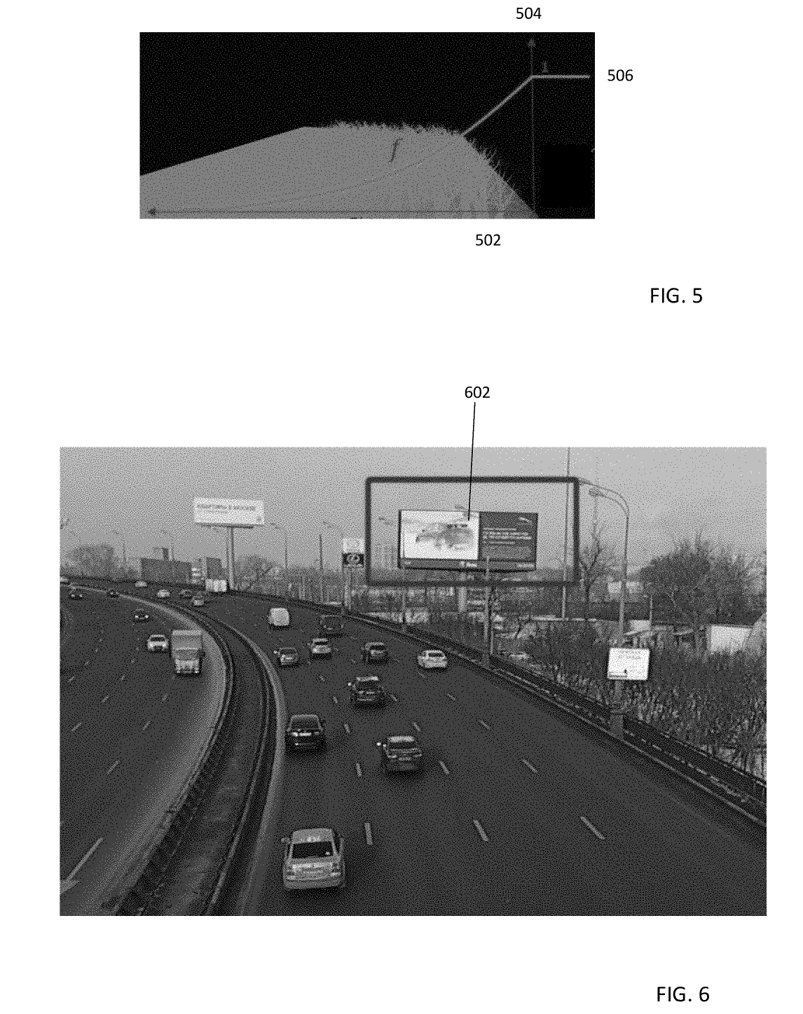

FIG. 5 depicts a visibility degradation in fog. In this manner, the x-axis depicts the fog color 502, the y-axis depicts the original color 504, and the curve denoted by f depicts a curve for fog removal 506. In this manner, the image data or the 3D representation may be adjusted to remove or diminish the appearance of fog or mist and thereby increase clarity for the driver. Fog or mist may be reduced or removed from the 3D representation using multiple image sensors. Such fog or mist removal may be performed in a variety of manners including, but not limited to, application of the Beer-Lambert-Law. For example, it is known that the following formula permits the calculation of a fog distribution:

$$f = {e}^{- d ⋆ b} = \frac{1}{{e}^{d ⋆ b}} \qquad ( 1 )$$

wherein d is equal to distance and b is equal to an attenuation factor or fog density. Such a calculated fog distribution may be conventionally used, for example, to insert a representation of fog into an image in which no fog appears. The inverse of this formula may be used to identify and remove fog in an image in which fog appears. In this manner, the image data and/or 3D representation may be corrected to remove fog or mist, thereby clarifying the image for the driver and providing additional visual information.

FIG. 6 depicts the identification and removal of distractions. The one or more processors may be configured to detect within the image data or 3D representation one or more distractions. The criteria for detecting distractions may be any criteria whatsoever as desired for the given implementation. In this case, the one or more processors may be configured to designate billboards as distractions, particularly, but not limited to situations where the billboards include screens or bright colors. In order to minimize distractions and to promote driver attention being directed to the roadway, the one or more processors may be configured to modify the image data or 3D representation to remove such distractions from the 3D image. In this case, the billboard 602 is depicted as being identified as a distraction, based on the rectangular markings surrounding the billboard. The one or more processors may then be configured to modify the billboard, such that the billboard is deleted, made transparent, blacked out, or otherwise rendered less distracting.

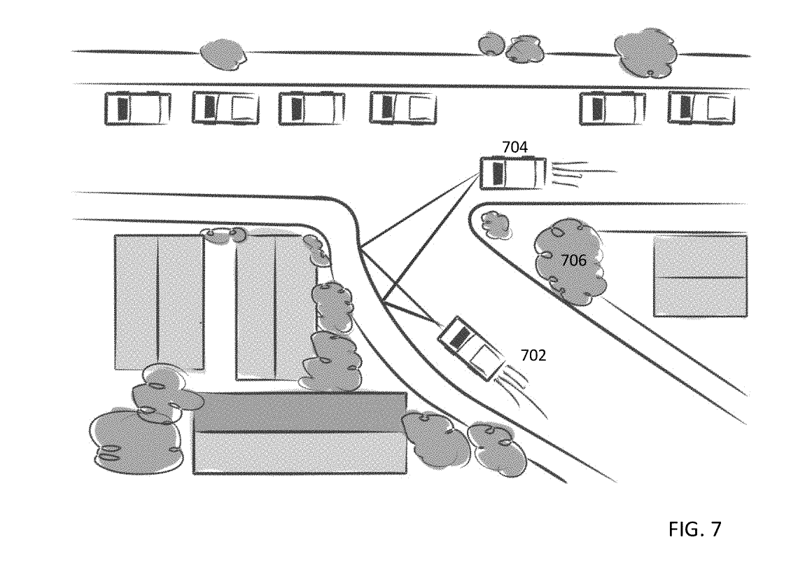

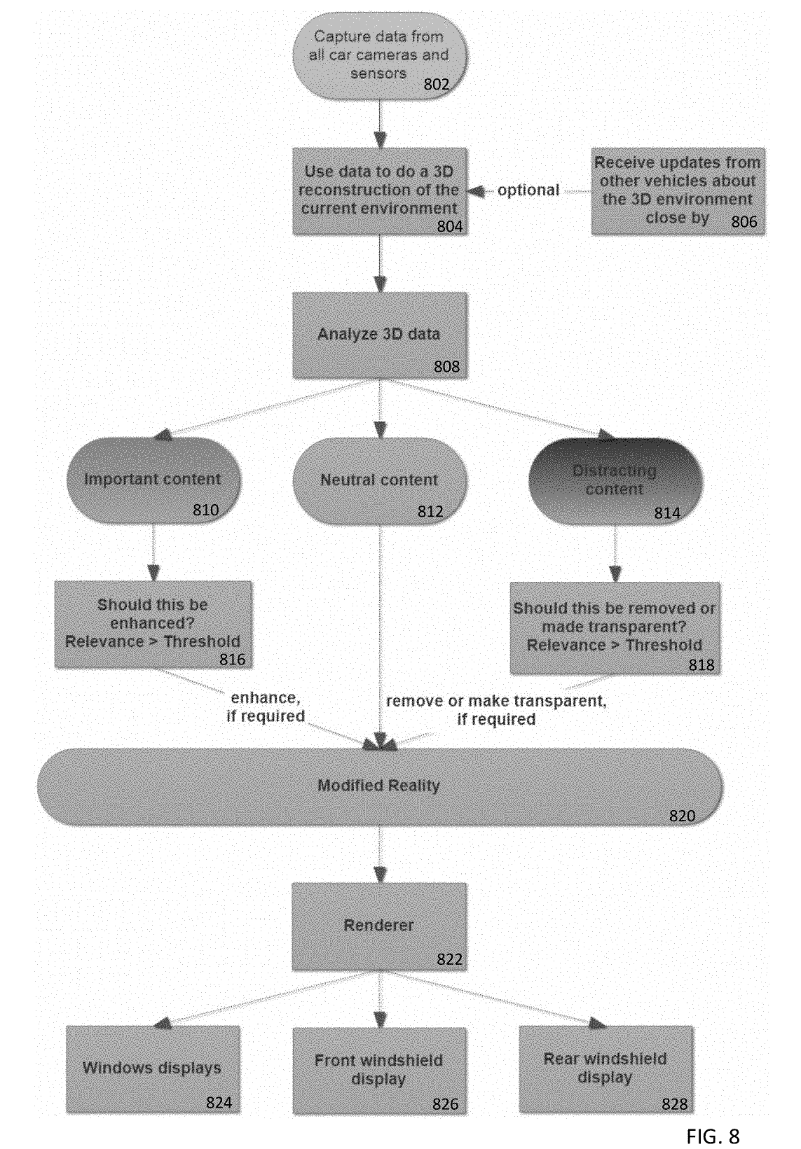

FIG. 7 depicts the modification of image data or 3D representation to permit the driver to see around a corner or obstacle. In this depiction, to vehicles, vehicle 702 and vehicle 704, are driving toward one another at approximately a 45° angle. Between the vehicles is an obstacle, which is depicted as a tree 706. The obstacle would prohibit the two vehicles from directly visualizing one another. In this situation, two methods for allowing the vehicles 702 and 704 to visualize one another despite obstacle 706 are possible. First, each vehicle is equipped with a plurality of image sensors, which are located at places different from the driver. That is, each image sensor is located some distance from the driver, and therefore has a different vantage from the driver. Although the driver's view may be blocked by obstacle 706, it is conceivable that one or more image sensors may have a view of the other vehicle while the driver's view continues to be blocked by the obstacle 706. By obtaining image data from an image sensor, the image data including another vehicle, the one or more processors may incorporate this data into the 3D representation. In so doing, the additional vehicle may be made visible. This may be achieved by removing the obstacle 706, making the obstacle 706 transparent or partially transparent, superimposing the other vehicle on top of the obstacle, or otherwise.

Alternatively, the two vehicles 702 and 704 may be in wireless communication with one another. That is, vehicle 704 may wirelessly transmit image data from one or more of its image sensors or its 3D representation to vehicle 702. Upon receiving this wireless transmission, vehicle 700 to may compare the image data or the 3D representation with its own image data or 3D representation and determine, from the comparison, that another vehicle is approaching. Vehicle 700 to may modify the image data or 3D representation accordingly.

FIG. 8 shows a flowchart for performing the methods described herein. According to this flowchart, data is captured from one or more car cameras and sensors 802, and the one or more processors use these data to perform a 3D reconstruction of the environment 804. Optionally, in performing the 3D reconstruction, the one or more processors may also include data received from other vehicles regarding the environment 806. Once the 3D representation is available, the 3D representation may be analyzed for a variety of factors 808. First, the 3D representation may be analyzed for important content 810. Important content may be any content to which a driver's attention should be directed. The importance of any content may be evaluated in terms of relevance being greater than a predetermined threshold 816. If it is determined that the relevance of important contact exceeds a predetermined threshold, the one or more processors may be configured to emphasize the important content. This may be performed by changing the brightness, color saturation, transparency, or otherwise of the important content or the content not designated as important content. Similarly, the 3D data may be analyzed for neutral content 812. In addition, the 3D data may be analyzed for distracting content 814. In the event that distracting content is detected, the relevance of the distracting content may be weighed against a predetermined threshold 818, and in the event that the relevance exceeds a predetermined threshold, the distracting content may be removed, made transparent, or otherwise modified. The result is a modified reality presentation 820. The modified reality is directed to a renderer 822, which is configured to display the modified reality on one or more displays. The displays may include, but are not limited to window displays 824, a front windshield display 826 and/or a rear windshield display 828.

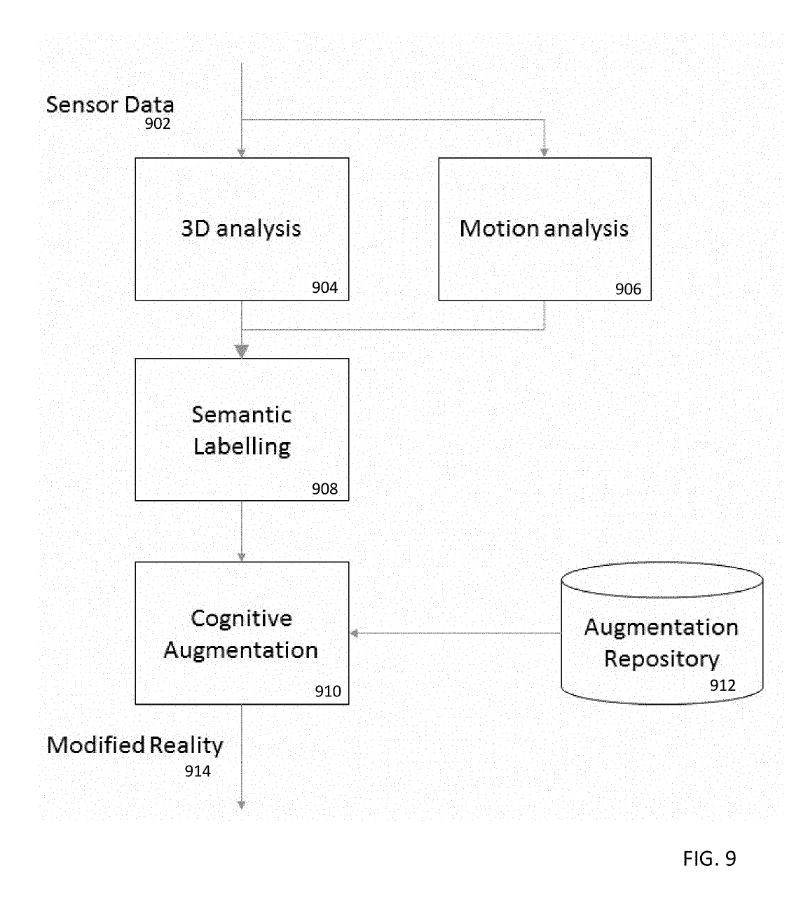

FIG. 9 depicts a flow diagram for motion analysis and 3D analysis. 3D analysis and motion analysis are known building blocks in the use of computer vision. These are able to assess a sparse and/or dense reconstruction of a 3D scene and motion of 3D objects, such as other vehicles or pedestrians. Known techniques include structure-from-motion, stereo analysis, bundle-adjustment and optical flow estimation techniques. In this manner, sensor data 902 may be analyzed according to a 3D analysis 904 and a motion analysis 906 technique. Upon completion of the analyses, semantic labeling 908 may be performed. Semantic labeling it may be understood as a natural language processing that assigns labels to words or phrases in a sentence that indicate their semantic role. Having completed the semantic labeling 908, one or more cognitive augmentation processes 910 may be performed. These may be achieved based on an augmentation repository 912. The result is a modified reality depiction 914.

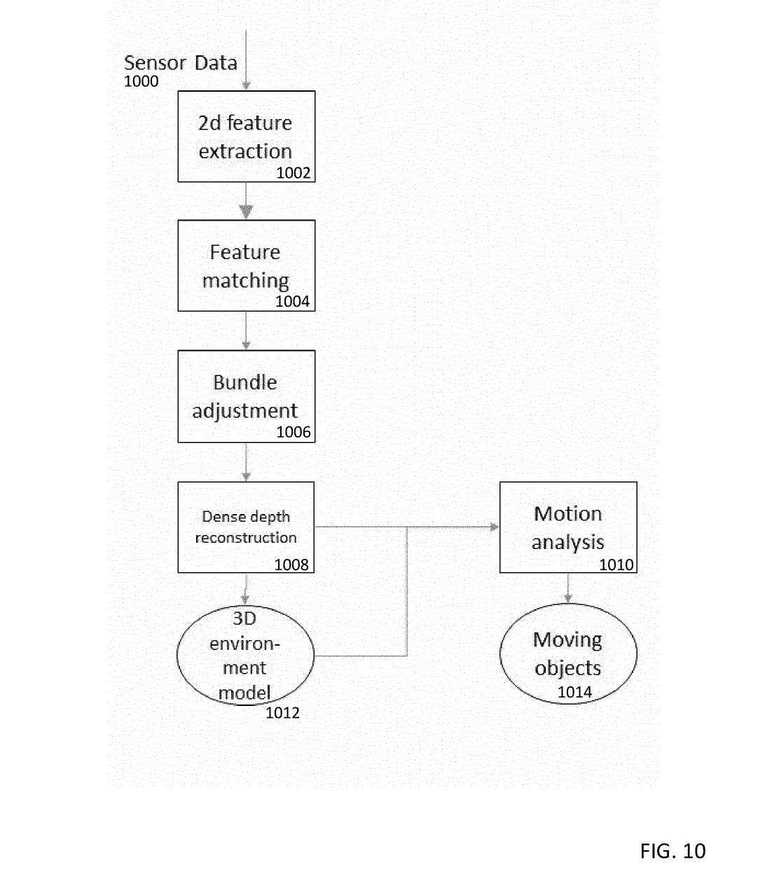

FIG. 10 depicts a 3D analysis in greater detail. In this case, sensor data 1000 is assessed for a two-dimensional feature extraction 1002. Feature matching is performed among the various images 1004. Thereafter, a bundle adjustment 1006 is performed, wherein bundle adjustment may be understood as the simultaneous refining of 3D coordinates that describe scene geometry, the parameters of the relative motion, and the optical characteristics of image sensors employed to acquire images, according to an optimality criterion involving the corresponding image projections of all points. Thereafter, a dense depth reconstruction 1008 is performed, and a three-dimensional model is created 1012. This may then continue, as described above, with a motion analysis 1010 and projection of moving objects 1014.

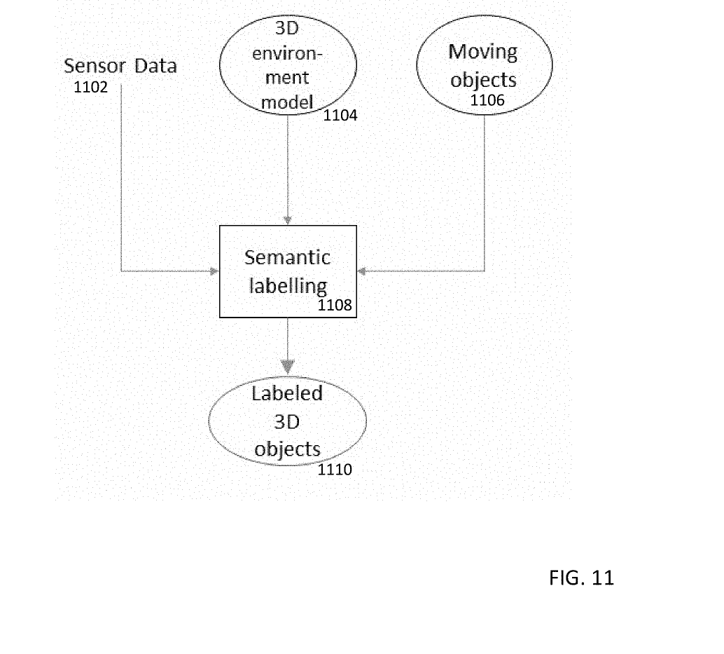

FIG. 11 depicts a data flow for semantic labeling. Most techniques described in literature label images and produce a label image (image with one color for each different object class). In contrast, this approach may use all available data and may produce a list of labeled and separated 3D and moving objects. The labeled data can then be edited as shown in the block “cognitive augmentation.” This process can modify objects, e.g., highlight roads, remove objects, or add additional data from an “augmentation repository”. One example for the latter would be to replace classes of object with modified or simpler models, e.g., a moving object with an arrow or pedestrians with avatars.

In this case, the sensor data 1102 may be directed to a semantic labeling processor 1108, which also receives the three-dimensional environment model 1104 and the moving objects analysis 1106. The semantic labeling procedure, as described herein, outputs one or more labeled 3D objects 1110.

Another example to highlight selected objects or to render the object with a modified intensity:
Function Render(object o):
Input object o
float amp=Importance(o)
for all pixel P in Projection(o):
Pixel p=amp*shading(P)
Store(p)

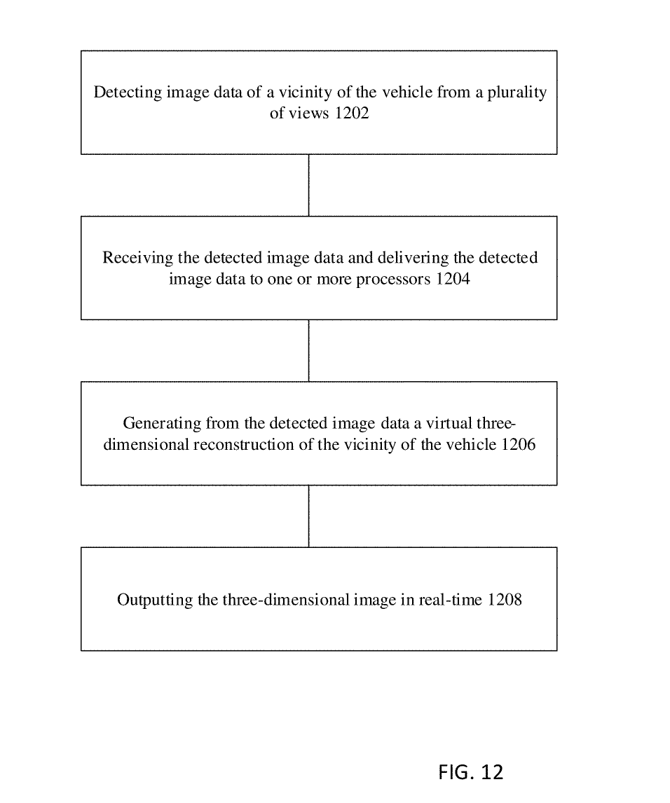

FIG. 12 depicts a method of real-time three-dimensional image reconstruction including detecting image data of a vicinity of the vehicle from a plurality of views 1202; receiving the detected image data and delivering the detected image data to one or more processors 1204; generating from the detected image data a virtual three-dimensional reconstruction of the vicinity of the vehicle 1206; and outputting the three-dimensional image in real-time 1208.

The vehicle may be equipped with a plurality of images sensors, which may be configured to detect image data corresponding to a vicinity of the vehicle. The image sensors may generally be any type of image sensor, which may include, but is not limited to, a monocamera, a stereocamera, depth camera, video camera, infrared camera, LIDAR camera, laser sensors, radar sensors, or any combination thereof.

Image data from the cameras may be transferred to one or more processors for 3D image reconstruction. Various methods are known to construct a 3D image based on a comparison of images including a common subject, as taken from different angles or vantages. According to one aspect of the disclosure, the 3D image may be generated using a procedure known as photogrammetry, which is generally the science of making measurements from photographs, such as for recovering exact positions of surface points.

Because photogrammetry relies on the comparison of images with a common subject taken from different positions, the vehicle may be equipped with multiple image sensors, which are offset along an x-axis, a y-axis, z-axis, or any combination thereof. The image sensors may be configured to have overlapping fields of view, such that they capture common images or subjects from different positions. Using one or more photogrammetry methods, one or more processors will compare the images, identify common subject matter within the images, and assess the differences in the depiction of the images to detect depth information and ultimately to generate a reconstruction of the subject matter in 3D. Any number of images may be compared for referenced for the 3D reconstruction. Any known photogrammetry technique or software may be used to generate the 3D reconstruction, without limitation.

According to another aspect of the disclosure, the camera's fixed positions may be used to facilitate the 3D reconstruction. In many photogrammetry applications, the exact image sensor positions, or even relative image sensor positions with respect to one another, may be unknown. This may place significant computational demands on the processors, as the image sensor positions are unknowns which must be taken into account in the photogrammetry process. In contrast to this scenario, however, the image sensors on or within the vehicle may be fixedly positioned, such that their positions relative to one another are known. This permits a simplified computational calculation in the photogrammetry process.

Although any image sensors may be used to gather image data, the vehicle may be equipped with stereo cameras which are capable of detecting depth information, rather than a plurality of individual, conventional cameras. The use of stereo cameras, and thereby the ability to utilize camera-detected depth information, rather than photogrammetry-detected depth information, may further simplify the computational demands. However, nothing in this disclosure should be understood to require the use of stereo cameras for any concepts disclosed herein.

According to one aspect of the disclosure, the vehicle may be equipped with one or more eye trackers, which are configured to track eye movements of the driver, and/or any passengers within the vehicle. Current eye tracker technology may operate at or above 240 Hz and is capable of quickly updating any changes in eye-movement. Moreover, eye trackers may be combined with processors configured to carry out prediction models to estimate future eye gaze based on eye rotations. The use of eye tracker technology may permit the 3D reconstruction and/or the display of the 3D reconstruction to be foveated, wherein one or more regions corresponding to the user's eye gaze is displayed at a greater resolution or a greater level of detail than one or more regions not corresponding to the user's eye gaze. By using a foveated image, a high level of detail may be depicted for an area corresponding to a user's attention. Moreover, remaining areas, not corresponding to the user's attention, may be depicted with a lower resolution or lower level of detail. This may result in reduced computational complexity and/or reduced processor requirement.

According to one aspect of the disclosure, the methods and principles described herein may be implemented in a windowless vehicle. That is, a user within the vehicle may depend entirely on one or more displays to achieve visual contact with a vicinity outside the vehicle. Where the user is a vehicle driver, the driver may depend entirely on information from the one or more displays to survey the driving environment, appreciate and evaluate hazards, and otherwise make driving decisions.

According to another aspect of the disclosure, one or more of the image sensors may be equipped with a precipitation clearing device. In many configurations, the one or more image sensors may be mounted fully or partially externally to the vehicle, and will therefore be subject to environmental factors such as precipitation. Precipitation, whether in the form of rain, mist, snow, or otherwise, may impair the functionality of the one or more image sensors. Accordingly, and to maintain strong image sensor functionality, the one or more image sensors may utilize a precipitation clearing device. The clearing device may take any form whatsoever, including, but not limited to, a device configured to wipe precipitation from the sensor or a corresponding lens.

According to another aspect of the disclosure, the 3D reconstruction may occur in real time. Conventionally, photogrammetry may occur in a postprocessing phase, which may be remote and may take place significantly after detection of image data from the image sensors. In contrast to the conventional approach, it is disclosed herein to provide a real time 3D image reconstruction based on a photogrammetry analysis of images from one or more image sensors. In so doing, the 3D reconstruction may be displayed for a user within the vehicle, such that the displayed 3D representation is a contemporaneous or near-contemporaneous representation of the data detected from the one or more image sensors. For example, the 3D reconstruction may be displayed within a predetermined number of milliseconds from the detection of image data. In some implementations, the 3D representation may be displayed within a predetermined number of microseconds from the detection of the image data. Because the 3D representation is used for assessing a vicinity of the vehicle and reaching driving decisions, the 3D representation may be deemed mission-critical and may be subject to one or more predetermined time constraints.

A real time 3D recreation of a vicinity of the vehicle based on comparison of image data may require significant processing power. Because of the safety issues associated with providing visual data for use in driving, it may be necessary to provide a real time three-dimensional image within various time constraints. That is, significant delay in creation of the 3D image may be detrimental to driving or driving safety. Depending on the number and complexity of video inputs, one or more processors operating at 100 to 1000 teraflops (Tflops) are believed to be capable of generating a 3D image in sufficient time as to minimize image generation lag and maintain safe driving conditions.

According to another aspect of the disclosure, the one or more processors may be further configured to modify the 3D reconstruction according to one or more modified reality algorithms. In this manner, modified reality may be distinguished from augmented reality, and that augmented reality relies on an overlay of one or more additional information structures upon a real image, whereas modified reality may include removing or altering one or more aspects of the real image. This may be made possible at least by the combination of images taken from a variety of positions. For example, when sufficient image sensors are placed along a front-end of the vehicle, the visual information available may correspond generally to the information that a driver would hypothetically have if the driver could move the driver's head from one side of the vehicle to the other side. That is, an opaque object, such as a sign, may be present such that it blocks a portion of the driver's direct field of vision. However, because the image sensors are arranged along one or more axes, synthesized image sensor data, or the 3D recreation arising therefrom, may include image data corresponding to an area behind the sign that the driver may not otherwise be able to see. In this situation, the one or more processors may be configured to implement a modified reality algorithm by removing the sign and replacing a region corresponding to the sign with image data training a region located behind the sign.

Modified reality capabilities may be further augmented by receiving images from one or more extra-vehicular sources. According to one aspect of the disclosure, the vehicle may be further equipped with a transceiver, configured to wirelessly receive transmissions of detected image data, which may then be compared with image data detected from the vehicle's image sensors, and may be included in the photogrammetry analysis to generate the 3D recreation. Such image data may be exchanged from vehicle to vehicle, such as by implementing a vehicle-to-vehicle exchange, or in exchange of image data according to any other wireless protocol. Other sources of wirelessly received image data include, but are not limited to, stationary wireless beacons connected to one or more image sensors, wireless transfers of image data from one or more mobile devices, or otherwise.

According to another aspect of the disclosure, the one or more processors may be configured to assess the image data for one or more dangers or hazards. Such dangers or hazards may include any object or situation associated with an elevated risk of collision or injury including, but not limited to, persons in or near the roadway, objects in or near the roadway, children within a vicinity of the vehicle, movement of a person or motor vehicle inconsistent with a traffic law or norm, or otherwise. In the event that a danger or hazard is detected, one or more actions may be taken to draw the driver's attention to the danger or hazard. For example, the danger or hazard may be modified to increase attention to the danger or hazard, such as by causing a portion of the 3D representation corresponding to the danger or hazard to blink, flash, increase brightness, increased saturation, or otherwise to be depicted in a manner to draw human attention. Correspondingly, one or more regions of the 3D representation not associated with the hazard or danger may be modified so as to reduce user attention, such as by reducing a brightness, reducing a saturation, or otherwise. According to one aspect of the disclosure, areas not corresponding to a perceived danger or hazard may be displayed in grayscale or black and white, whereas areas corresponding to a perceived danger or hazard may be displayed in color.

According to another aspect of the disclosure, one or more objects in the image data or 3D representation may be recognized and replaced by a preconfigured corresponding model. In this manner, the vehicle may be configured with a memory on which is stored a plurality of three-dimensional models. Such models may be any models whatsoever, whether vehicles, signs, or otherwise. According to one aspect of the disclosure, one or more 3D vehicle models may be stored on the memory for use in a modified reality version of the 3D representation. In this manner, the one or more processors may be configured to detect within the image data or the 3D representation a shape corresponding to a predetermined 3D model. The predetermined 3D model may then be included in the 3D representation in place of the corresponding shape. In this manner, clearer, additional detail may be made available for the driver. For example, in the event that the vehicle is behind a BMW 5 Series F10, the one or more processors may be configured to identify the BMW from the image data or corresponding portion of the 3D representation, and to replace the portion of the 3D representation corresponding to the image data of the BMW with a stored 3D model of the BMW. This may provide added detail and visual information for the driver compared to the detail and visual information available from image sensor data, particularly when environmental factors may diminish the quality of the BMW's representation within the image sensor data, such as during fog, rain, or other environmental factors. According to another aspect of the disclosure, the one or more processors may be configured to modify the 3D model image to correspond to one or more factors of the corresponding vehicle from the image data, such as by matching the vehicle's position and orientation. Furthermore, the 3D model of the vehicle may be modified to match a light status of the vehicle captured within the image sensor data. That is, in the event that the brake lights of the BMW are illuminated, the 3D model of the BMW may be modified to depict illuminated brake lights. Such modifications may be made to the 3D model without limitation.

The one or more processors may further be configured to detect a distraction within the image data or the 3D recreation. For example, in certain jurisdictions it is known to place advertisements along roads, streets, or highways. Some such advertisements, such as billboards, may include brightly colored or even animated screens. These advertisements are designed to be distracting and to divert attention from the road to the advertising content. The one or more processors may be configured to recognize such advertisements and to modify the image data or 3D representation accordingly to reduce distraction. According to one aspect of the disclosure, such identified advertisements may be deleted entirely from the 3D representation, and the region corresponding to the advertisement may be filled in from image data obtained from additional vantage points or positions. According to another aspect of the disclosure, distracting advertisements may be made less distracting by diminishing their brightness, color saturation, opaqueness, or otherwise changing their visual appearance. Similarly, the one or more processors may be configured to identify other distracting objects. According to one aspect of the disclosure, falling leaves or leaves piled on a road may be distracting for drivers, and the one or more processors may be configured to identify and remove such leaves from the image data or 3D recreation. Any deleted areas may be replaced by other image data garnered from additional vantage points.

According to another aspect of the disclosure, the generated 3D real-time image may be displayed on a stereo display. By use of a stereo display, depth perception may be communicated to the driver by utilizing stereopsis for binocular vision. Any type of stereo display may be used without limitation.

The vehicle may be equipped with a memory, configured to store a plurality of maps. The one or more processors may be configured to generate the real time three-dimensional recreation based on the detected image data and one or more stored maps. That is, map data from the stored maps may be combined with the image data to enhance the three-dimensional recreation. The stored map data may be two-dimensional or three-dimensional. Alternatively, the stored data may be available remotely and wirelessly transmitted to the vehicle.

It is described herein to modify the three-dimensional image based on the determined relevance of any one or more portions of the image exceeding a predetermined threshold. Various examples of such image modifications based on meeting or exceeding the predetermined threshold are provided throughout, such as, for example, modifying a color, an opacity, a pattern, or otherwise within the three-dimensional image. According to one aspect of the disclosure, the relevance of any portion of the image may change, even in real-time, depending on at least one of a variety of factors. For example, an obstacle at a distance from the road may not, in and of itself, be designated as being highly relevant; however, if it is detected that the obstacle is moving toward the road, its designated relevance may increase. Similarly, the mere detection of children—particularly if the children are not near the road—may, in and of itself, not be given an especially high relevance; however, if the children begin to move in the direction of the road, their relevance may be increased. In this way, the relevance of an object may initially be assessed as being beneath the predetermined threshold, but based on a change in a circumstance related to the object (such as direction of movement, distance from road, etc.), the relevance of the object may be sufficiently altered to change from not meeting the predetermined threshold to exceeding the predetermined threshold.

In a similar manner, the predetermined threshold may be dynamic, and a suitable value for the predetermined threshold may be selected based on one or more factors identified in the image. In relying on the same examples, a higher predetermined threshold may be assigned to a static obstacle that is not present on the roadway, or to a dynamic obstacle that is moving away from the roadway. On the other hand, a lower threshold may be implemented for an obstacle that is moving toward the roadway. In this manner, a higher threshold may be used for the mere presence of an object or person, until it is determined that the object or person is moving toward the roadway, at which time a lower threshold may be implemented. Even where the higher threshold is too high to trigger a modification of the three-dimensional image, the lower threshold may be sufficiently low to trigger an image modification. In this manner, changes in obstacles may trigger a change in the three-dimensional image by dynamically modifying the corresponding risk threshold.

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of (objects)”, “multiple (objects)”) referring to a quantity of objects expressly refers more than one of the said objects. The terms “group (of)”, “set (of)”, “collection (of)”, “series (of)”, “sequence (of)”, “grouping (of)”, etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The term “processor” as, for example, used herein may be understood as any kind of entity that allows handling data. The data may be handled according to one or more specific functions executed by the processor. Further, a processor as used herein may be understood as any kind of circuit, e.g., any kind of analog or digital circuit. The term “handle” or “handling” as for example used herein referring to data handling, file handling or request handling may be understood as any kind of operation, e.g., an I/O operation, and/or any kind of logic operation. An I/O operation may include, for example, storing (also referred to as writing) and reading.

A processor may thus be or include an analog circuit, digital circuit, mixed-signal circuit, logic circuit, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

Differences between software and hardware implemented data handling may blur. A processor, controller, and/or circuit detailed herein may be implemented in software, hardware and/or as hybrid implementation including software and hardware.

The term “system” (e.g., a computing system, a control system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

As used herein, the term “memory”, and the like may be understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa.

The term “vehicle” as used herein may be understood as any suitable type of vehicle, e.g., any type of ground vehicle, a watercraft, an aircraft, or any other type of vehicle. In some aspects, the vehicle may be a motor vehicle (also referred to as automotive vehicle). As an example, a vehicle may be a car also referred to as a motor car, a passenger car, etc. As another example, a vehicle may be a truck (also referred to as motor truck), a van, etc.

The term “lane” with the meaning of a “driving lane” as used herein may be understood as any type of solid infrastructure (or section thereof) on which a vehicle may drive. In a similar way, lanes may be associated with aeronautic traffic, marine traffic, etc., as well.

Additional aspects of the disclosure will be described in the following examples.

In Example 1, a vehicle is disclosed comprising a plurality of image sensors, configured to detect image data of a vicinity of the vehicle from a plurality of views; one or more displays, configured to display images; one or more processors, configured to generate from the detected image data a real-time three-dimensional reconstruction of the vicinity of the vehicle; and display the real-time, three-dimensional image on the one or more displays.

In Example 2, the vehicle of claim 1 is disclosed, wherein the one or more processors are configured to generate the real-time three-dimensional reconstruction using one or more photogrammetry techniques.

In Example 3, the vehicle of claim 1 or 2 is disclosed, wherein the one or more processors are further configured to detect distracting content within the three-dimensional image, and if an evaluation of the relevance of the distracting content exceeds a predetermined threshold, to modify an appearance of the distracting content.

In Example 4, the vehicle of claim 3 is disclosed, wherein the modification of the distracting content comprises at least one of modifying a brightness of the distracting content, modifying a hue of the distracting content, modifying a color saturation of the distracting content, modifying a transparency of the distracting content, or removing the distracting content.

In Example 5, the vehicle of any one of claims 1 to 4 is disclosed, wherein the one or more processors are further configured to detect important content within the three-dimensional image, and if an evaluation of the relevance of the important content exceeds a predetermined threshold, to modify an appearance of the three-dimensional image.

In Example 6, the vehicle of claim 5 is disclosed, wherein the modification of the three-dimensional image comprises at least one of modifying a brightness, hue, color saturation or transparency of the important content; or modifying a brightness, hue, color saturation or transparency of content not designated as the important content.

In Example 7, the vehicle of claim 5 or 6 is disclosed, wherein the modification of the three-dimensional image comprises emphasizing the important content.

In Example 8, the vehicle of any one of claims 1 to 7 is disclosed, wherein one or more processors are further configured to modify the generated three-dimensional image to reduce an appearance of fog within the three-dimensional image.

In Example 9, the vehicle of any one of claims 1 to 8 is disclosed, wherein one or more processors are further configured to modify the generated three-dimensional image to reduce an appearance of precipitation within the three-dimensional image.

In Example 10, the vehicle of claim 8 or 9 is disclosed, wherein one or more processors are further configured to reduce the appearance of fog or precipitation using a Beer-Lambert formula.

In Example 11, the vehicle of any one of claims 1 to 10 is disclosed, further comprising a transceiver, configured to wirelessly receive image data corresponding to a vicinity of the vehicle is disclosed, wherein the one or more processors are further configured to generate the real-time three-dimensional reconstruction of the vicinity of the vehicle using the detected image data from the plurality of image sensors and the wirelessly received image data.

In Example 12, the vehicle of any one of claims 1 to 11 is disclosed, wherein the vehicle has no windows.

In Example 13, the vehicle of any one of claims 1 to 12 is disclosed, wherein the one or more displays are stereoscopic displays.

In Example 14, the vehicle of any one of claims 1 to 12 is disclosed, wherein the one or more displays are autostereoscopic displays.

In Example 15, the vehicle of any one of claims 1 to 14 is disclosed, wherein the one or more processors are configured to generate the real-time three-dimensional reconstruction of the vicinity of the vehicle from the detected image data and one or more stored maps.

In Example 16, the vehicle of claim 15 is disclosed, further comprising a memory, configured to store a plurality of maps for generation of the real-time three-dimensional reconstruction of the vicinity of the vehicle.

In Example 17, a real-time image generating device is disclosed comprising: a plurality of image sensors, configured to detect image data of a vicinity of a vehicle from a plurality of views; one or more displays, configured to display images; one or more processors, configured to generate from the detected image data a real-time three-dimensional reconstruction of the vicinity of the vehicle; and display the real-time, three-dimensional image on the one or more displays.

In Example 18, the real-time image generating device of claim 17 is disclosed, wherein the one or more processors are configured to generate the real-time three-dimensional reconstruction using one or more photogrammetry techniques.

In Example 19, the real-time image generating device of claim 17 or 18 is disclosed, wherein the one or more processors are further configured to detect distracting content within the three-dimensional image, and if an evaluation of the relevance of the distracting content exceeds a predetermined threshold, to modify an appearance of the distracting content.

In Example 20, the real-time image generating device of claim 19 is disclosed, wherein the modification of the distracting content comprises at least one of modifying a brightness of the distracting content, modifying a hue of the distracting content, modifying a color saturation of the distracting content, modifying a transparency of the distracting content, or removing the distracting content.

In Example 21, the real-time image generating device of any one of claims 17 to 20 is disclosed, wherein the one or more processors are further configured to detect important content within the three-dimensional image, and if an evaluation of the relevance of the important content exceeds a predetermined threshold, to modify an appearance of the three-dimensional image.

In Example 22, the real-time image generating device of claim 21 is disclosed, wherein the modification of the three-dimensional image comprises at least one of modifying a brightness, hue, color saturation or transparency of the important content; or modifying a brightness, hue, color saturation or transparency of content not designated as the important content.

Om Example 23, the real-time image generating device of claim 21 or 22 is disclosed, wherein the modification of the three-dimensional image comprises emphasizing the important content.

In Example 24, the real-time image generating device of any one of claims 17 to 23 is disclosed, wherein one or more processors are further configured to modify the generated three-dimensional image to reduce an appearance of fog within the three-dimensional image.

In Example 25, the real-time image generating device of any one of claims 17 to 24 is disclosed, wherein one or more processors are further configured to modify the generated three-dimensional image to reduce an appearance of precipitation within the three-dimensional image.

In Example 26, the real-time image generating device of claim 24 or 25 is disclosed, wherein one or more processors are further configured to reduce the appearance of fog or precipitation using a Beer-Lambert formula.

In Example 27, the real-time image generating device of any one of claims 17 to 26 is disclosed, further comprising a transceiver, configured to wirelessly receive image data corresponding to a vicinity of the vehicle is disclosed, wherein the one or more processors are further configured to generate the real-time three-dimensional reconstruction of the vicinity of the vehicle using the detected image data from the plurality of image sensors and the wirelessly received image data.

In Example 28, the real-time image generating device of any one of claims 17 to 27 is disclosed, wherein the vehicle has no windows.

In Example 29, the real-time image generating device of any one of claims 17 to 28 is disclosed, wherein the one or more displays are stereoscopic displays.

In Example 30, the real-time image generating device of any one of claims 17 to 29 is disclosed, wherein the one or more displays are autostereoscopic displays.

In Example 31, the real-time image generating device of any one of claims 17 to 30 is disclosed, wherein the one or more processors are configured to generate the real-time three-dimensional reconstruction of the vicinity of the vehicle from the detected image data and one or more stored maps.

In Example 32, the real-time image generating device of claim 31 is disclosed, further comprising a memory, configured to store a plurality of maps for generation of the real-time three-dimensional reconstruction of the vicinity of the vehicle.

In Example 33, a means for real-time image generation is disclosed comprising: a plurality of image sensing means, configured to detect image data of a vicinity of a vehicle from a plurality of views; one or more displaying means, configured to display images; one or more processing means, configured to generate from the detected image data a real-time three-dimensional reconstruction of the vicinity of the vehicle; and display the real-time, three-dimensional image on the one or more displaying means.

In Example 34, the means for real-time image generation of claim 33 is disclosed, wherein the one or more processing means are configured to generate the real-time three-dimensional reconstruction using one or more photogrammetry techniques.

In Example 35, the means for real-time image generation of claim 33 or 34 is disclosed, wherein the one or more processing means are further configured to detect distracting content within the three-dimensional image, and if an evaluation of the relevance of the distracting content exceeds a predetermined threshold, to modify an appearance of the distracting content.

In Example 36, the means for real-time image generation of claim 35 is disclosed, wherein the modification of the distracting content comprises at least one of modifying a brightness of the distracting content, modifying a hue of the distracting content, modifying a color saturation of the distracting content, modifying a transparency of the distracting content, or removing the distracting content.

In Example 37, the means for real-time image generation of any one of claims 33 to 36 is disclosed, wherein the one or more processing means are further configured to detect important content within the three-dimensional image, and if an evaluation of the relevance of the important content exceeds a predetermined threshold, to modify an appearance of the three-dimensional image.

In Example 38, the means for real-time image generation of claim 37 is disclosed, wherein the modification of the three-dimensional image comprises at least one of modifying a brightness, hue, color saturation or transparency of the important content; or modifying a brightness, hue, color saturation or transparency of content not designated as the important content.

In Example 39, the means for real-time image generation of claim 37 or 38 is disclosed, wherein the modification of the three-dimensional image comprises emphasizing the important content.

In Example 40, the means for real-time image generation of any one of claims 33 to 39 is disclosed, wherein one or more processing means are further configured to modify the generated three-dimensional image to reduce an appearance of fog within the three-dimensional image.

In Example 41, the means for real-time image generation of any one of claims 33 to 40 is disclosed, wherein one or more processing means are further configured to modify the generated three-dimensional image to reduce an appearance of precipitation within the three-dimensional image.

In Example 42, the means for real-time image generation of claim 40 or 41 is disclosed, wherein one or more processing means are further configured to reduce the appearance of fog or precipitation using a Beer-Lambert formula.

In Example 43, the means for real-time image generation of any one of claims 33 to 42 is disclosed, further comprising a transceiver, configured to wirelessly receive image data corresponding to a vicinity of the vehicle is disclosed, wherein the one or more processing means are further configured to generate the real-time three-dimensional reconstruction of the vicinity of the vehicle using the detected image data from the plurality of image sensors and the wirelessly received image data.

In Example 44, the means for real-time image generation of any one of claims 33 to 43 is disclosed, wherein the vehicle has no windows.

In Example 45, the means for real-time image generation of any one of claims 33 to 44 is disclosed, wherein the one or more displaying means are stereoscopic displaying means.

In Example 46, the means for real-time image generation of any one of claims 33 to 44 is disclosed, wherein the one or more displaying means are autostereoscopic displaying means.

In Example 47, the means for real-time image generation of any one of claims 33 to 46 is disclosed, wherein the one or more processing means are configured to generate the real-time three-dimensional reconstruction of the vicinity of the vehicle from the detected image data and one or more stored maps.

In Example 48, the means for real-time image generation of claim 47 is disclosed, further comprising a memory, configured to store a plurality of maps for generation of the real-time three-dimensional reconstruction of the vicinity of the vehicle.

In Example 49, a method of real-time three-dimensional image reconstruction is disclosed comprising detecting image data of a vicinity of a vehicle from a plurality of views; generating from the detected image data a real-time three-dimensional reconstruction of the vicinity of the vehicle; and displaying the real-time, three-dimensional image on one or more displays.

In Example 50, the method of claim 49 is disclosed, further comprising generating the real-time three-dimensional reconstruction using one or more photogrammetry techniques.

In Example 51, the method of claim 49 or 50 is disclosed, further comprising detecting distracting content within the three-dimensional image, and if an evaluation of the relevance of the distracting content exceeds a predetermined threshold, to modify an appearance of the distracting content.

In Example 52, the method of claim 51 is disclosed, wherein the modification of the distracting content comprises at least one of modifying a brightness of the distracting content, modifying a hue of the distracting content, modifying a color saturation of the distracting content, modifying a transparency of the distracting content, or removing the distracting content.

In Example 53, the method of any one of claims 49 to 52 is disclosed, further comprising detecting important content within the three-dimensional image, and if an evaluation of the relevance of the important content exceeds a predetermined threshold, to modify an appearance of the three-dimensional image.

In Example 54, the method of claim 53 is disclosed, wherein the modification of the three-dimensional image comprises at least one of modifying a brightness, hue, color saturation or transparency of the important content; or modifying a brightness, hue, color saturation or transparency of content not designated as the important content.

In Example 55, the method of claim 53 or 54 is disclosed, wherein the modification of the three-dimensional image comprises emphasizing the important content.

In Example 56, the method of any one of claims 49 to 55 is disclosed, further comprising modifying the generated three-dimensional image to reduce an appearance of fog within the three-dimensional image.

In Example 57, the method of any one of claims 49 to 56 is disclosed, further comprising modifying the generated three-dimensional image to reduce an appearance of precipitation within the three-dimensional image.

In Example 58, the method of claim 56 or 57 is disclosed, further comprising reducing the appearance of fog or precipitation using a Beer-Lambert formula.

In Example 59, the method of any one of claims 49 to 58 is disclosed, further comprising wirelessly receiving image data corresponding to a vicinity of the vehicle, and generating the real-time three-dimensional reconstruction of the vicinity of the vehicle using the detected image data.

In Example 60, the method of any one of claims 49 to 59 is disclosed, wherein the vehicle has no windows.

In Example 61, the method of any one of claims 49 to 60 is disclosed, further comprising displaying the three-dimensional reconstruction on one or more stereoscopic displays.

In Example 62, the method of any one of claims 49 to 60 is disclosed, further comprising displaying the three-dimensional reconstruction on one or more autostereoscopic displays.

In Example 63, the method of any one of claims 49 to 62 is disclosed, further comprising generating the real-time three-dimensional reconstruction of the vicinity of the vehicle from the detected image data and one or more stored maps.

In Example 64, the method of claim 63 is disclosed, further comprising storing a plurality of maps for generation of the real-time three-dimensional reconstruction of the vicinity of the vehicle on a memory.

In Example 65, a non-transient computer readable medium is disclosed, configured to cause one or more processors to perform the method of detecting image data of a vicinity of a vehicle from a plurality of views; generating from the detected image data a real-time three-dimensional reconstruction of the vicinity of the vehicle; and displaying the real-time, three-dimensional image on one or more displays.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced

What is claimed is:

1. A real-time image generating device comprising:
a plurality of image sensors, configured to detect image data of a vicinity of the vehicle from a plurality of views;
a receiver, configured to receive the detected image data and deliver the detected image data to one or more processors, and
the one or more processors, configured to
generate from the detected image data a virtual three-dimensional reconstruction of the vicinity of the vehicle; and
output the three-dimensional image in real-time.

2. The real-time image generating device of claim 1, wherein the plurality of images sensors are configured to detect image data at a first time period, wherein the one or more processors are configured to display the three-dimensional image on one or more displays at a second time period, and wherein the first time period and the second time period are less than 100 milliseconds apart, less than 10 milliseconds apart, or less than 100 microseconds apart.

3. The real-time image generating device of claim 1, wherein the one or more processors are configured to generate the real-time three-dimensional reconstruction using one or more photogrammetry techniques.

4. The real-time image generating device of claim 1, wherein the one or more processors are further configured to detect distracting content within the three-dimensional image, and if an evaluation of the relevance of the distracting content exceeds a predetermined threshold, to modify an appearance of the distracting content.

5. The real-time image generating device of claim 4, wherein the modification of the distracting content comprises at least one of modifying a brightness of the distracting content, modifying a hue of the distracting content, modifying a color saturation of the distracting content, modifying a transparency of the distracting content, or removing the distracting content.

6. The real-time image generating device of claims 1, wherein one or more processors are further configured to modify the generated three-dimensional image to reduce an appearance of fog within the three-dimensional image.

7. The real-time image generating device of claim 1, wherein one or more processors are further configured to modify the generated three-dimensional image to reduce an appearance of precipitation within the three-dimensional image.

8. The real-time image generating device of claim 1, further comprising a transceiver, configured to wirelessly receive image data corresponding to a vicinity of the vehicle, wherein the one or more processors are further configured to generate the real-time three-dimensional reconstruction of the vicinity of the vehicle using the detected image data from the plurality of image sensors and the wirelessly received image data.

9. The real-time image generating device of claim 1, further comprising displaying the three-dimensional image on one or more stereoscopic displays or autostereoscopic displays.

10. The real-time image generating device of claim 1, wherein the one or more processors are configured to generate the real-time three-dimensional reconstruction of the vicinity of the vehicle from the detected image data and one or more stored maps.

11. A method of real-time three-dimensional image reconstruction comprising:
detecting image data of a vicinity of the vehicle from a plurality of views;
receiving the detected image data and delivering the detected image data to one or more processors;
generating from the detected image data a virtual three-dimensional reconstruction of the vicinity of the vehicle; and
outputting the three-dimensional image in real-time.

12. The method of claim 11, wherein the image data are detected at a first time period; wherein the three-dimension image is displayed at a second time period; and wherein the first time period and the second time period are less than 100 milliseconds apart, less than 10 milliseconds apart, or less than 100 microseconds apart.

13. The method of claim 11, further comprising detecting distracting content within the three-dimensional image, and if an evaluation of the relevance of the distracting content exceeds a predetermined threshold, to modify an appearance of the distracting content.

14. The method of claim 13, wherein the modification of the distracting content comprises at least one of modifying a brightness of the distracting content, modifying a hue of the distracting content, modifying a color saturation of the distracting content, modifying a transparency of the distracting content, or removing the distracting content.

15. The method of claim 11, further comprising detecting important content within the three-dimensional image, and if an evaluation of the relevance of the important content exceeds a predetermined threshold, to modify an appearance of the three-dimensional image.

16. The method of claim 15, wherein the modification of the three-dimensional image comprises at least one of modifying a brightness, hue, color saturation or transparency of the important content; or modifying a brightness, hue, color saturation or transparency of content not designated as the important content.

17. The method of claim 16, wherein the modification of the three-dimensional image comprises emphasizing the important content by at least one of modifying a brightness, hue, color saturation or transparency of the important content; or modifying a brightness, hue, color saturation or transparency of content not designated as the important content.

18. The method of claim 11, further comprising wirelessly receiving image data corresponding to a vicinity of the vehicle, and generating the real-time three-dimensional reconstruction of the vicinity of the vehicle using the detected image data.

19. A non-transient computer readable medium configured to cause one or more processors to perform the method of:
detecting image data of a vicinity of the vehicle from a plurality of views;
receiving the detected image data and delivering the detected image data to one or more processors;
generating from the detected image data a virtual three-dimensional reconstruction of the vicinity of the vehicle; and
displaying the three-dimensional image;
wherein the three-dimensional image is displayed in at least real-time.

20. A non-transient computer readable medium of claim 19, wherein the medium is further configured to cause the one or more processors to detect distracting content within the three-dimensional image, and if an evaluation of the relevance of the distracting content exceeds a predetermined threshold, to modify an appearance of the distracting content.
